(19) United States
(12) Patent Application Publication
(10) Pub. No.: US 2014/0357377 A1
(43) Pub. Date: Dec. 4, 2014

(54) METHOD AND SYSTEM FOR PROVIDING ONLINE SPORTS GAME FOR RECOMMENDING SQUAD

(71) Applicant: Intellectual Discovery Co., Ltd., Seoul (KR)

(72) Inventor: Hyun Cho Jung, Seoul (KR)

(73) Assignee: INTELLECTUAL DISCOVERY CO., LTD., Seoul (KR)

(21) Appl. No.: 14/363,929

(22) PCT Filed: Nov. 28, 2012
(86) PCT No.: PCT/KR2012/010194

§ 371 Date: Jun. 9, 2014

(30) Foreign Application Priority Data
Dec. 9, 2011 (KR) 10-2011-0132394

(51) Int. Cl. A63F 13/30; A63F 13/00

(52) U.S. Cl. CPC A63F 13/30; A63F 13/005
USPC 463/42

(57) ABSTRACT

Disclosed is a game providing technique which is executed by an online sports game providing system for providing an online sports game to at least one game client through a network. The online sports game providing method includes (a) generating at least one of first recommended squad information, (b) generating at least one of second recommended squad information based on statistics on a squad used by at least one second user relating to the first user, and (c) providing the at least one of first or second recommended squad information to a game client of the first user.

### TECHNICAL FIELD

The present invention relates to a game providing technique. More particularly, the present invention relates to a method and system for providing an online sports game for analyzing a squad of an online game user and recommending a squad to the user.

### BACKGROUND ART

Online-based games have been substantially developed according to development of computing devices and network surroundings. The online-based games have started to develop substantially since differences from offline games that perform a predetermined action for a conventional program have been accepted in that the online games generate interaction between users.

The online games in the earlier stage mostly included multiplayer online role playing games (MORPG), but various kinds of online games are currently provided according to an increase of bandwidths of networks and development of computing devices. Accordingly, sports online games for providing ball sports such as soccer, basketball, and baseball to the user through an online game are provided in various ways.

It is very important for the user to manage a team with good players in the sports online game. That is, it is a big target for the user to make a team with an excellent squad to play an online sports game.

However, in the case of a conventional sports online game, it was difficult to acquire information on the excellent squad. That is, the squad information on other users is acquired through a notice board of a corresponding game when attempting to acquire information on the squad applicable in an excellent manner in the sports online game, so the squad information cannot be acquired in the game. Further, reliability of the squad information acquired from another user is problematically very low.

### DISCLOSURE

### Technical Problem

The present invention has been made in an effort to provide a technique for providing an online sports game for generating recommended squad information based on squad statistics of an online sports game and easily providing a squad decision to a user in a game, regarding the online sports game.

The present invention has been made in another effort to provide a technique for providing an online sports game for distinguishing squads of all users, a squad of a top-level user with a high game ranking, and a squad of a friend user to generate a recommended squad, and thereby providing wider squad information and option possibilities to the user.

The present invention has been made in another effort to provide a technique for providing an online sports game for comparing a squad of a specific user and a recommended squad to provide information on a player character lacking in a squad of a user and an acquisition method, and thereby allowing making a squad more conveniently.

### Technical Solution

In exemplary embodiments, a method for providing an online sports game is executed by an online sports game providing system for providing an online sports game to at least one game client through a network. An exemplary embodiment of the present invention provides a method for providing an online sports game, including: (a) generating at least one of first recommended squad information based on statistics on a squad used by the online sports game; (b) generating at least one of second recommended squad information based on statistics on the squad used by at least one second user relating to a first user; and (c) providing the at least one of first or second recommended squad information to a game client of the first user.

In the exemplary embodiments, the method for providing an online sports game is performed by an online sports game providing system for providing an online sports game to at least one game client through a network. The method for providing an online sports game includes: (a) generating at least one of first recommended squad information based on statistics on a squad used by the online sports game; (b) selecting at least one of second recommended squad information relating to a user of a game client from the first recommended squad information; and (c) providing the at least one of second recommended squad information to the game client of the user.

In exemplary embodiments, the method for providing an online sports game is performed by an online sports game providing system for providing an online sports game to at least one game client through a network. The method for providing an online sports game includes: (a) providing information on a plurality of formations provided by the online sports game; (b) providing information on each position corresponding to one formation selected by a game client of a first user and a player character applicable to each corresponding position; and (c) when receiving information on one player character selected for each position from the game client of the first user, generating a virtual squad based on it.

In exemplary embodiments, the online sports game providing system can be connected to at least one game client through a network, and provides an online sports game to the at least one game client. The online sports game providing system includes a squad database, a squad statistics unit, and a game provision controller. The squad database stores squad information including formation information on a management team of each user of the online sports game and per-position player character information. The squad statistics unit generates statistics on squads stored in the squad database or a squad on at least one user provided by a game provision controller. The game provision controller generates recommended squad information by selecting n formations that are most frequently used and a per-position player character based on statistics generated by the squad statistics unit, and provides the recommended squad information to a game client.

In exemplary embodiments, a recording medium records a program for executing a method for providing an online sports game, and the program is a program that can be driven by an online sports game providing system for providing an online sports game to at least one game client through a network. The program includes: (a) a function for generating at least one of first recommended squad information based on statistics on a squad used in the online sports game; (b) a function for generating at least one of second recommended squad information based on statistics on a squad used by at least one second user relating to a first user; and (c) a function for providing the at least one of first or second recommended squad information to a game client of the first user.

In exemplary embodiments, a recording medium records a program for executing a method for providing an online sports game, and the program is a program that can be driven by an online sports game providing system for providing an online sports game to at least one game client through a network. The program includes: (a) a function for generating at least one of recommended squad information based on statistics on a squad used in the online sports game; (b) a function for selecting at least one of second recommended squad information relating to a user of a game client from the first recommended squad information; and (c) a function for providing the at least one of second recommended squad information to the game client of the user.

In exemplary embodiments, a recording medium records a program for executing a method for providing an online sports game, and the program is a program that can be driven by an online sports game providing system for providing an online sports game to at least one game client through a network. The program includes: (a) a function for providing information on a plurality of formations provided by the online sports game; (b) a function for providing information on each position corresponding to one formation selected by a game client of a first user and a player character applicable to each corresponding position; and (c) a function for, when receiving information on one player character selected for each position from the game client of the first user, generating a virtual squad based on it.

### Advantageous Effects

According to the embodiment of the present invention, recommended squad information is generated based on squad statistics of the online sports game and is provided in the game to easily provide a squad decision to the user.

According to the embodiment of the present invention, the recommended squad is generated by distinguishing the squads of all users, the squad of the top-level user with a high game ranking, and the squad of a friend user, thereby providing wider squad information and option possibilities to the user.

According to the embodiment of the present invention, the squad of a specific user is compared to the recommended squad to provide information on the player character lacking in the squad of a user and an acquisition method, thereby allowing making the squad more conveniently.

### DESCRIPTION OF THE DRAWINGS

FIG. 1 shows a reference drawing of an online sports game providing system and a game client according to an exemplary embodiment of the present invention.

FIG. 2 shows a schematic diagram of an online sports game providing system according to an exemplary embodiment of the present invention.

FIG. 3 shows a schematic diagram of an online sports game providing system according to another exemplary embodiment of the present invention.

FIG. 4 shows a reference drawing of squad data stored in a squad database shown in FIG. 2 and FIG. 3 according to an exemplary embodiment of the present invention.

FIG. 5 shows a reference drawing of squad data stored in a squad database shown in FIG. 2 and FIG. 3 according to another exemplary embodiment of the present invention.

FIG. 6 shows a reference drawing of information on a player character provided by an online sports game according to an exemplary embodiment of the present invention.

FIG. 7 shows a reference drawing of a squad recommendation screen provided to a game client by an online sports game providing system according to an exemplary embodiment of the present invention.

FIG. 8 shows a reference drawing of a virtual squad generation screen provided to a game client by an online sports game providing system according to an exemplary embodiment of the present invention.

FIG. 9 shows a flowchart of a method for providing a quest of an online sports game according to an exemplary embodiment of the present invention.

FIG. 10 shows a flowchart of a method for providing a quest of an online sports game according to another exemplary embodiment of the present invention.

### MODE FOR INVENTION

A technique is disclosed through a structural or functional description of an exemplary embodiment, and the scope of the disclosed technique is not to be understood to be restricted by the exemplary embodiment described in the specification. That is, it is to be understood that the exemplary embodiment is intended to cover various modifications and equivalent arrangements included within the spirit and scope of the appended claims.

In addition, terms that are described in the present invention are to be understood as follows.

Terms such as “first,” “second,” etc., may be used to distinguish one constituent element from another constituent element, and the scope must not be restricted by the terms. For example, a first constituent element may be called a second constituent element, and similarly, the second constituent element may be called the first constituent element.

It is noted that when it is described that a certain constituent element is “connected” to another constituent element, they may be directly connected or electrically connected to each other, and a third constituent element may exist therebetween. On the contrary, it is also noted that when it is described that a certain constituent element is “directly connected” or “directly electrically connected” to another constituent element, a third constituent element does not exist therebetween. In addition, other expressions that describe relationships among constituent elements such as, “between,” “just between,” “adjacent to,” and “directly adjacent to” must be understood in a like manner.

An expression used in the singular encompasses an expression of the plural, unless it has a clearly different meaning in the context, and it is to be understood that the terms such as “including,” “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Identification codes (e.g., a, b, c, etc.,) in respective stages are used for better comprehension and ease of description, but they do not necessarily describe an order of the respective stages, and the respective stages may be performed in a different order from the described order unless a specific order is written in the context. That is, the respective stages may be performed according to the described order, they may be performed substantially simultaneously, or they may be performed in an opposite order.

The present invention can be implemented as a computer-readable code in a computer-readable recording medium, and the computer-readable recording medium includes all types of recording apparatuses in which data that can be read by a computer system is stored. Examples of the computer-readable recording media include a ROM, a RAM, a CD-ROM, a magnetic tape, a floppy disk, an optical data storage unit, a non-memory semiconductor, etc., and in addition, they include a recording medium implemented in the form of a carrier wave (for example, transmission through the Internet). The computer readable recording medium may also be distributed to computer devices connected by a network so that the computer readable codes are stored and executed in a distributed fashion.

In addition, unless defined otherwise in the detailed description, all the terms have the same meaning as meanings generally understood by those skilled in the art to which the present invention pertains. Generally used terms such as terms defined in a dictionary should be interpreted as the same meanings as meanings within a context of the related art, and should not be interpreted as ideally or excessively formal meanings unless clearly defined in the present specification.

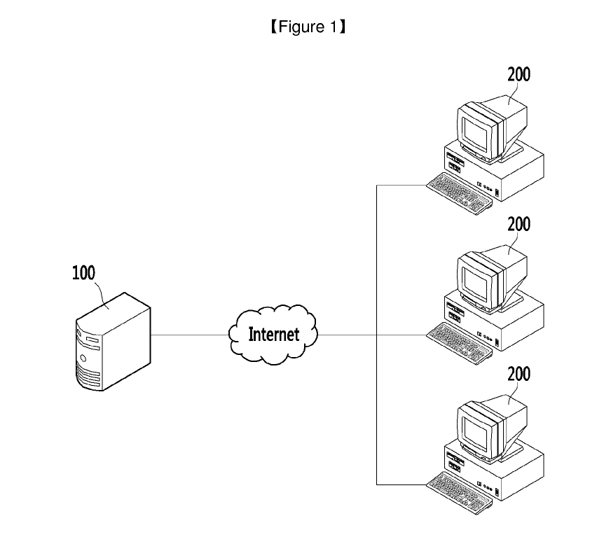

FIG. 1 shows a reference drawing of an online sports game providing system and a game client according to an exemplary embodiment of the present invention.

The online sports game providing system 100 (hereinafter, a game providing system) may simultaneously provide a sports game to at least one user (game client) through an online network environment. The online sports game provided by the disclosed game providing system 100 is a sports game based on multiple users. For example, the online sports game may be realizations of team sports such as soccer, baseball, basketball, or handball as online games.

The game providing system 100 may provide an online sports game (hereinafter, a game). The game providing system 100 may provide various sorts of games configured with a plurality of matches such as tournaments or leagues as well as simple single-unit games.

The game providing system 100 may provide player versus environment (PVE) games in addition to player versus player (PVP) online games

Further, it may provide PVP games among multiple users and PVE games between multiple users and environments.

The game providing system 100 may provide a predetermined environment to a team of a specific user. For an example of basketball for one team with five persons, when one player character is controlled by the user, four remaining player characters of the corresponding team may perform actions (events) that are predetermined by an environment (game engine) without control by the user.

The game providing system 100 may perform at least partial real-time data exchange with at least one game client 200 so as to provide an online sports game.

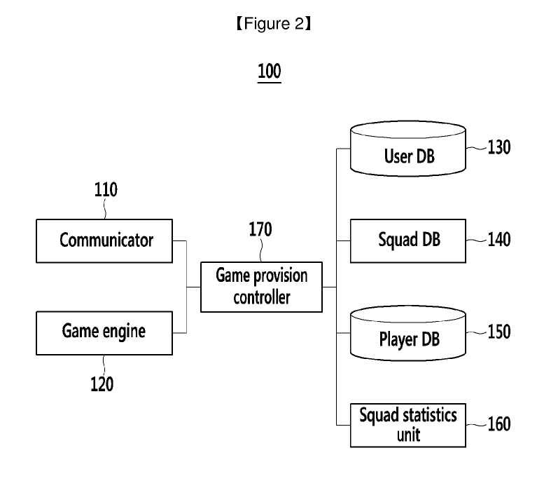

The game providing system 100 will be described in further detail with reference to FIG. 2.

The game client 200 is a game providing means that may be driven at a user terminal. The user terminal is a terminal configured with a central processing unit and a memory device such as a PC, a tablet PC, or a smartphone.

The game client 200 may maintain access to or communication with the game providing system 100, and may provide a sports game to the user. According to the exemplary embodiment, the game client 200 may load at least a part of the game engine for driving a game. For example, at least a part of predetermined operations needed for providing a sports online game may be performed by the game client 200 for the purpose of fast processing.

FIG. 2 shows a schematic diagram of an online sports game providing system according to an exemplary embodiment of the present invention.

Referring to FIG. 2, the game providing system 100 may include a communicator 110, a game engine 120, a squad database 140, a squad statistics unit 160, and a game provision controller 170. In an exemplary embodiment, the game providing system 100 may further include a user database 130 and a player database 150.

The communicator 110 may set or maintain a communication condition for the game client 200 and provision of a game by control of the game provision controller 150.

The game engine 120 is configured to drive a game, and may provide a sports game to the user in linkage with the game client 200. In the disclosed exemplary embodiment, the game engine 120 is described to be a separate configuration from the game provision controller 150, and according to the exemplary embodiment, the game engine 120 may be realized as a function of the game provision controller 150. In an exemplary embodiment, at least a part of the game engine 120 may be loaded to the game client 200.

The user database 130 may store management team information and game rankings for respective users of the online sports game. The management team information is information on the team managed by the user in the online sports game, and for example, it may include a team name, player character information belonging to the corresponding team, game money information on the user, and friend user information on the user, and the game ranking information of the user may include a ranking order for all users in the corresponding game.

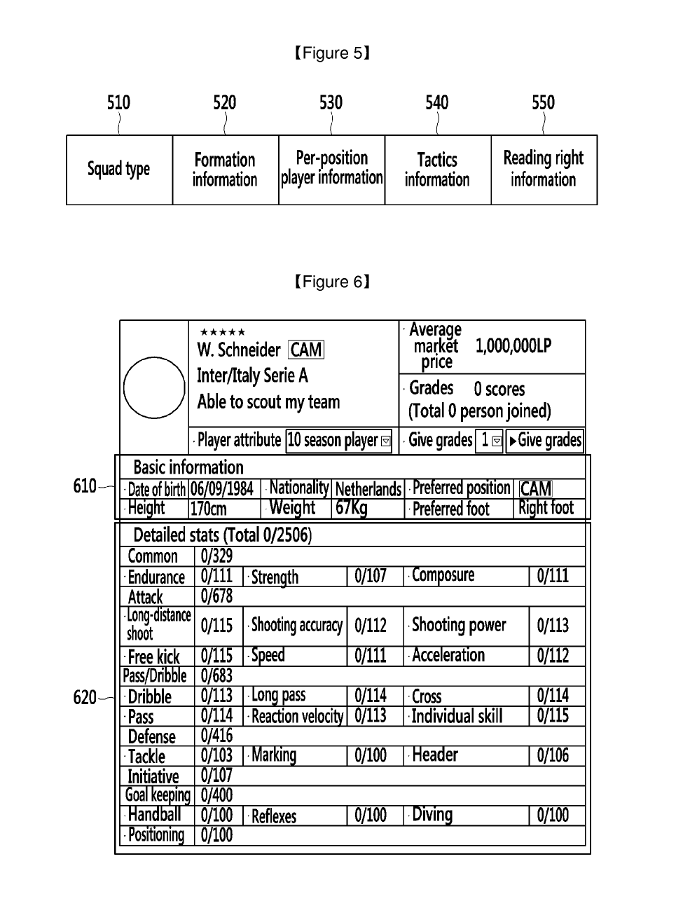

The squad database 140 may store squad information including formation information on the management team of each user of the online sports game and player character information for respective positions. Here, the squad information may include information on the formation used by the corresponding team, and player character information for respective positions included in the formation. The data stored in the squad database 140 will be described later with reference to FIG. 4 and FIG. 5.

The player database 150 may include information on the player character and acquisition information on the player character. Here, the information on the player character may include basic information reflecting actual information on the corresponding player, and numerical information on various capability points used in the online game. A detailed description thereof will be given later with reference to FIG. 6. The acquisition information on the player character may include information on the means for the user to acquire the corresponding player character. For example, when using a player card that is randomly selected, the acquisition information may include information on the player card that may choose the corresponding player character. Assuming that a JooYoung Park player character may be acquired through a 2011 Korea national team player card and a 2011 Arsenal player card, acquisition information on the JooYoung Park player card may be expressed as identity information for the 2011 Korea national team player card and the 2011 Arsenal player card. As another example, when an auction house system is in use, the game provision controller 170 may check a player card registered to the auction house, and may generate acquisition information by using link information on such auction registration when the JooYoung Park player card is registered to the auction house.

The squad statistics unit 160 may generate statistics on the squad for at least one user provided by the squads and stored in the squad database 140 or the game provision controller.

In further detail, the squad statistics unit 160 may generate statistics based on a usage frequency on all squads stored in the squad database 140. That is, it may analyze squad information that all users are using or that was used in the past and stored, may select a predetermined number of squads in a most frequently used order, and may generate the same as all user squad statistics information. Also, the squad statistics unit 160 may generate statistics on the squad for a specific user provided by the game provision controller 170 according to a usage frequency. For example, when the game provision controller 170 provides information on one hundred top rankers, the squad statistics unit 160 may generate top ranker squad statistics information with reference to the squads of the one hundred top rankers. In another way, when the game provision controller 170 provides information on friends of a specific user, the squad statistics unit 160 may generate friend squad statistics information with reference to the usage frequency on the squads of the friends of the specific user.

The game provision controller 170 may select n formations that are used the most and player characters for respective positions based on statistics generated by the squad statistics unit 160 to generate recommended squad information, and may provide the generated recommended squad information to the game client 200. For example, the game provision controller 170 may use at least one of all user squad statistics information, top ranker squad statistics information, and friend squad statistics information generated by the squad statistics unit 160, may select n formations that are used the most and the player characters for respective positions, and may generate recommended squad information based on them.

In an exemplary embodiment, the game provision controller 170 may generate recommended squad information based on top ranker squad statistics. In further detail, the game provision controller 170 may search the user database 130 to select n users who have high game rankings, may request squad statistics on the selected n users from a squad statistics unit, and may generate recommended squad information based on squad statistics for the n users. In the case of a game in which a user's level is assigned, the game provision controller 170 may select n users whose levels are greater than a predetermined number, and may generate recommended squad information.

In an exemplary embodiment, the game provision controller 170 may use squad statistics on friend users for respective users to generate recommended squad information. In further detail, the game provision controller 170 may select at least one second user registered as a friend of a first user from the user database 130, and may request squad statistics on the selected second user from the squad statistics unit 160. The game provision controller 170 may generate recommended squad information based on the squad statistics on at least one second user provided by the squad statistics unit 160.

In an exemplary embodiment, the game provision controller 170 may provide acquisition information on the player character. In further detail, the game provision controller 170 may provide acquisition information on a plurality of player characters included in the recommended squad information to the game client. For this purpose, the game provision controller 170 may search acquisition information on the player character recorded in the player database 150, and may check acquisition information on the corresponding player. Here, the game provision controller 170 may update acquisition information on the player character. For example, in the case of acquisition information through an auction house, the game provision controller 170 may update acquisition information on the player character each time an event such as a registration of a new player card or a sellout of a registered specific player card is generated.

In an exemplary embodiment, the game provision controller 170 may compare a squad of a current user and a recommended squad to identify a player character (i.e., a player character that requires a supplement so as to make the squad of the current user a recommended squad) who does not exist in the squad of the current user, and may provide acquisition information on the identified player character to the game client 200 of the user.

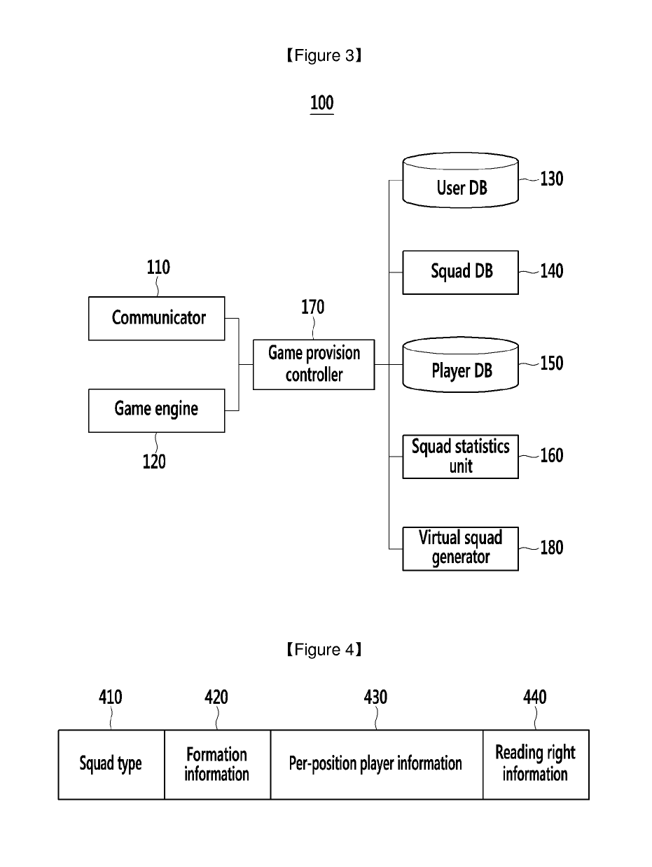

FIG. 3 shows a schematic diagram of an online sports game providing system according to another exemplary embodiment of the present invention. The exemplary embodiment shown in FIG. 3 may provide a function for generating a virtual squad. Here, descriptions of the exemplary embodiment disclosed with reference to FIG. 3 that are to the same as or correspond to the descriptions provided with reference to FIG. 2 will be omitted.

Referring to FIG. 3, in further detail, the game providing system may further include a virtual squad generator 180 in the constituent elements of FIG. 2.

The virtual squad generator 180 may generate or modify a virtual squad, rather than the current squad of the management team of the user. In further detail, the virtual squad generator 180 may provide information on a plurality of formations provided by the online sports game. When the game client selects one of a plurality of corresponding formations, it may provide information on the position on the selected formation and the player character applicable to the corresponding position. For this purpose, the virtual squad generator 180 may access the squad database 140 and the player database 150 and search necessary information. The virtual squad generator 180 may generate the virtual squad based on the player characters for respective positions selected from the game client 200. An example of the providing of a virtual squad will be described later with reference to FIG. 8.

The game provision controller 170 may store the generated virtual squad in the squad database 140. The game provision controller 170 may provide a virtual squad according to a request by the game client 200, and when the game client 200 requests to modify the virtual squad, it may request the modification from the virtual squad generator 180.

In an exemplary embodiment, the game provision controller 170 may perform a squad recommendation by assigning a reading right for each user on the virtual squad information. For example, the virtual squad generated by the top ranker may assign a reading right to all users, and the virtual squad information generated by the specific user may assign a reading right to the friends. In further detail, the game provision controller 170 checks whether the user having generated the virtual squad belongs to the n persons with high game rankings in the virtual squad generator 180, and if so, it may set to provide the virtual squad information generated by the corresponding user to all users of the online game. If not, it may set to provide the virtual squad information to the corresponding user and the user registered as friends.

FIG. 4 shows a reference drawing of squad data stored in a squad database shown in FIG. 2 and FIG. 3 according to an exemplary embodiment of the present invention, and FIG. 5 shows a reference drawing of squad data stored in a squad database shown in FIG. 2 and FIG. 3 according to another exemplary embodiment of the present invention.

Referring to FIG. 4, the squad data may include a squad type 410, formation information 420, per-position player information 430, and reading right information 440.

The squad type 410 is identification information for identifying whether the corresponding squad information is recommended squad information or virtual squad information.

The formation information 420 is information on the formation used by the corresponding squad. In the exemplary case of the online soccer game, it may include information such as 4-4-2, 3-4-3, or 4-2-3-1.

The per-position player information 430 is information on the player characters applicable to the respective positions of the corresponding squad.

The reading right information 440 is information on the reading right on corresponding squad information. For example, the squad information for assigning a reading right to the friends of a specific user may include identification information on the corresponding friends.

Regarding the example shown in FIG. 5, the squad information may further include tactics information 540 into the information disclosed in FIG. 4.

The tactics information 540 may include tactics information used in the corresponding squad. For example, it may include per-position tendency information and per-situation (e.g., attack, defense, counterattack, etc.,) per-position information.

FIG. 6 shows a reference drawing of information on a player character provided by an online sports game according to an exemplary embodiment of the present invention. Player character information stored in the player database 150 will now be described with reference to FIG. 6.

The player character information may be configured with basic information 610 and stats information 620.

The basic information 610 signifies general information on the corresponding player. For example, it may include a name, age, nationality, height, weight, frequently-used foot, and position of the corresponding player.

The stats information 620 signifies capability point information on the corresponding player applied in the game. FIG. 6 shows an example of the online soccer game, capability points are classified as common things, and attack, pass/dribble, defense, goalkeeping, and numbers for respective capabilities are assigned for the respective characters. However, the illustrated exemplary embodiment is an embodiment so it is obviously expressed with other distinctions or numerical ranges.

The disclosed technique calculates the capability point with numerical data on the player character as shown in FIG. 6 so it is possible to recommend the player for each position of the virtual squad based on the player capability points as described.

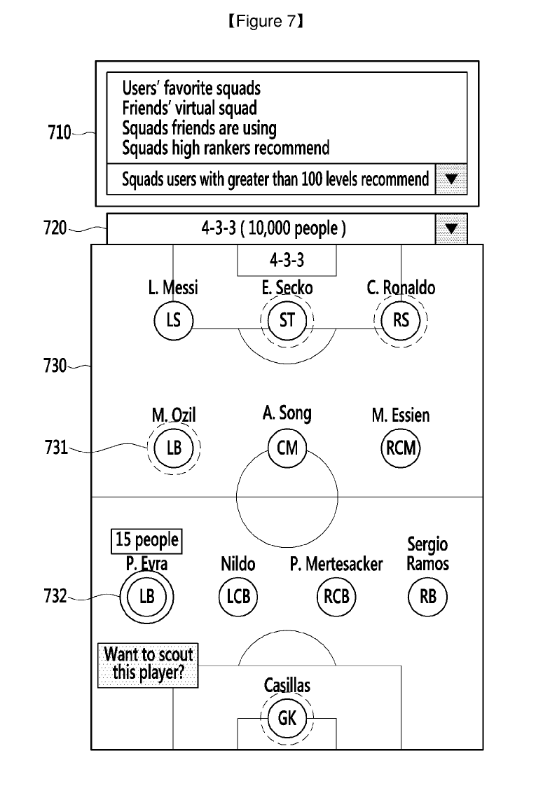

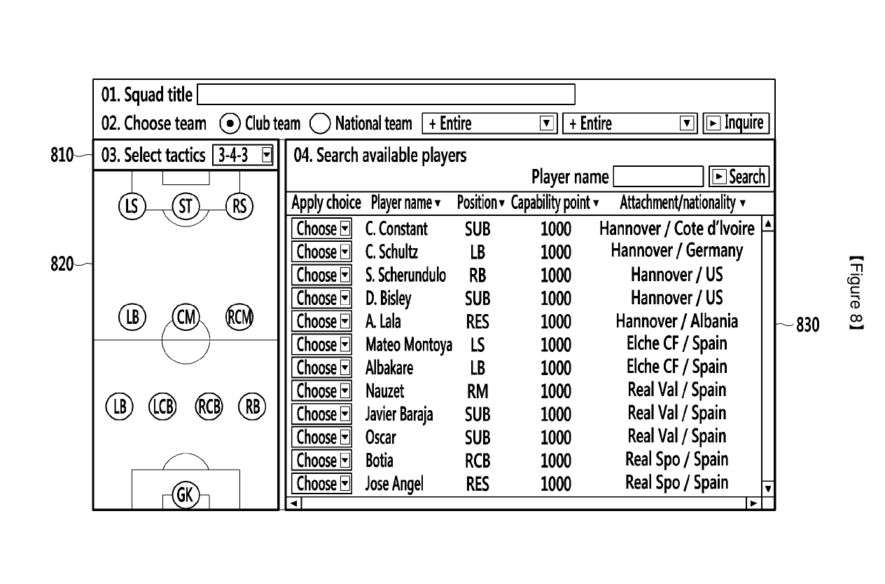

FIG. 7 shows a reference drawing of a squad recommendation screen provided to a game client by an online sports game providing system according to an exemplary embodiment of the present invention.

An identification item 710 provides a list of recommended squad information to the user. In a like manner of the illustrated exemplary embodiment, it provides a list on the recommended squad information respectively generated by using all of user squad statistics, top ranker squad statistics, and friend squad statistics. The illustrated exemplary embodiment shows that the squad using the statistics of users whose levels are greater than 100 is selected.

The identification item 720 expresses the formation used by the selected recommended squad and the user using the corresponding squad.

The identification item 730 shows the position for the squad and per-position player information. Here, as described above, it may be compared with the squad of the user, which may then be shown. That is, in the shown exemplary embodiment, a player character belonging to a white circle is a player character lacking in the squad of the user. The character denoted as a white circle 732 with a solid line is a player selected by the current game client 200, indicating a registration state of the corresponding player. That is, fifteen P. Evra player characters are registered to the auction house. A character shown with a white circle 731 of a dotted line signifies a player that is not selected by the game client 200.

FIG. 8 shows a reference drawing of a virtual squad generation screen provided to a game client by an online sports game providing system according to an exemplary embodiment of the present invention.

An identification item 810 provides a selection on the formation for generating a virtual squad.

An identification item 820 illustrates a selected formation, which may be shown when the player character is selected for each formation.

An identification item 830 provides a list for selecting a player character for each position.

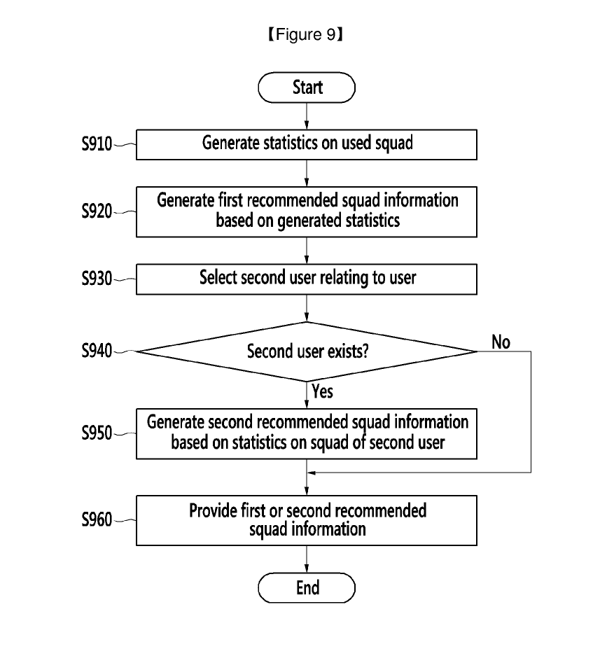

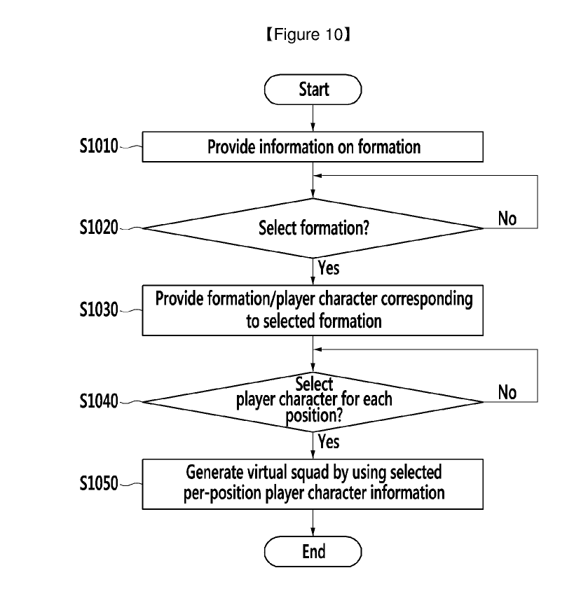

Hereinafter, various exemplary embodiments of a method for providing an online sports game will be described with reference to FIG. 9 and FIG. 10. Since the exemplary embodiments to be described below are performed by the described game providing system 100, no corresponding contents will be repeated, but a person of ordinary skill in the art may easily understand an exemplary embodiment of a method for providing an online sports game to be described from the above-provided descriptions.

FIG. 9 shows a flowchart of a method for providing an online sports game according to an exemplary embodiment of the present invention.

Referring to FIG. 9, in further detail, in the method for providing an online sports game according to an exemplary embodiment of the present invention, the game providing system 100 may generate statistics on a squad used in an online sports game (S910), and may generate at least one piece of first recommended squad information based on the generated statistics (S920).

The game providing system 100 may select a second user relating to the user (S930), and when the second user exists (S940, Yes), it may generate at least one piece of second recommended squad information based on statistics on the squad used by the second user (S950).

The game providing system 100 may provide a recommended squad by providing at least one piece of the first or second recommended squad information to the game client 200 of the user (S960). Here, squad information may include formation information and per-position player character information.

In an exemplary embodiment for S910 and S920, the game providing system 100 may collect formation information on all squads used in the online sports game, and may select n formations from the collected formation information in the most frequently used order. The game providing system 100 may then distinguish the squads using n formations from among all the squads, and may extract information on the per-position player character for the distinguished squads to generate first recommended squad information.

In an exemplary embodiment for S910 and S920, the game providing system 100 may select n users with high game rankings in the online sports game, and may analyze the squads of the n selected users to select m formations in the most frequently used order. The game providing system 100 distinguishes the squad using m formations from among the squads of the n users, and may extract information on the per-position player character for the distinguished squad to generate first recommended squad information.

In an exemplary embodiment for S930 to S950, the game providing system 100 may select at least one second user registered as a friend of the user, may analyze the at least one second user, and may extract the most frequently used formation and per-position player character information used in the corresponding formation to generate second recommended squad information.

In an exemplary embodiment for S960, the game providing system 100 provides a list of first or second recommended squad information to the game client 200, and may provide the formation for one of the first or second recommended squad information selected by the game client 200 and the per-position player character information to the game client.

In an exemplary embodiment, the method for providing an online sports game may provide information by comparing the squad of the user with the recommended squad. The game providing system 100 may compare the squad of the user with the first or second recommended squad information, and may provide information on the player character lacking in the squad of the user to the game client 200.

In further detail, the game providing system 100 may check information on the squad of the user, and may compare the squad of the user with one of the first or second recommended squad information selected by the game client 200. The game providing system 100 may provide information on the player character lacking in the squad of the first user to the game client 200 according to a comparison result. Here, the game providing system 100 may provide acquisition information on the lacking player character to the game client 200.

In another exemplary embodiment, the method for providing an online sports game may select recommended squad information relating to a specific user from the entire generated squad information, and may provide the same.

In further detail, the game providing system 100 may generate at least one of first recommended squad information based on statistics on the squad used in the online sports game, and may select at least one of second recommended squad information relating to the user of the game client 200 from the first recommended squad information. The game providing system 100 may provide a recommended squad by providing at least one of second recommended squad information to the game client 200.

FIG. 10 shows a flowchart of a method for providing an online sports game according to another exemplary embodiment of the present invention. Another exemplary embodiment shown in FIG. 10 relates to a technique for generating a virtual squad.

Referring to FIG. 10, in further detail, in a method for providing an online sports game according to an exemplary embodiment, the game providing system 100 may provide information on a plurality of formations provided by the online sports game to the game client 200 (S1010).

When one of the formations is selected by the game client 200 of the first user (S1020, Yes), the game providing system 100 may provide information on each position corresponding to the selected formation and the player character applicable to the corresponding position (S1030).

When one player character is selected for each position and the game providing system 100 receives corresponding information from the game client 200 (S1040, Yes), the game providing system 100 may generate virtual squad information based on it (S1050).

In an exemplary embodiment, the method for providing an online sports game may set a reading right of virtual squad information for each user. In further detail, when the first user belongs to the n persons with high game rankings, the game providing system 100 may be set to provide the virtual squad information generated by the first user to all users of the online game. If not, the game providing system 100 may be set to provide the virtual squad information to at least one second user registered as a friend of the first user.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method for providing an online sports game in a method for providing an online sports game executed by a system for providing an online sports game for providing an online sports game to at least one game client through a network, comprising:
(a) generating at least one of first recommended squad information based on statistics on a squad used by the online sports game;
(b) generating at least one of second recommended squad information based on statistics on the squad used by at least one second user relating to a first user; and
(c) providing the at least one of first or second recommended squad information to a game client of the first user.

2. The method of claim 1, wherein the squad information includes
formation information and per-position player character information.

3. The method of claim 2, wherein (a) includes:
collecting formation information on all squads in the online sports game;
selecting n formations that are the most frequently used from among the collected formation information; and
distinguishing squads using the n formations from among all the squads, extracting information on per-position player character for the distinguished squads, and generating the first recommended squad information.

4. The method of claim 2, wherein (a) includes:
selecting n users who correspond to game rankings from a first ranking to an n-th ranking in the online sports game;
analyzing squads of the n selected users and selecting m formations in a most frequently used order; and
distinguishing squads using the m formations from among the squads of the n users, extracting information on per-position player character for the distinguished squad, and generating the first recommended squad information.

5. The method of claim 3, wherein (b) includes:
selecting at least one second user registered as a friend of the first user; and
analyzing the at least one second user, extracting a most frequently used formation and per-position player character information used in a corresponding formation, and generating the second recommended squad information.

6. The method of claim 2, wherein (c) includes:
providing a list on the first or second recommended squad information to the game client; and
providing a formation on one of the first and second recommended squad information selected by the game client and per-position player character information to the game client.

7. The method of claim 1, wherein the method for providing an online sports game further includes
(d) comparing a squad of the first user with the first or second recommended squad information and providing information on a player character lacking in the squad of the first user.

8. The method of claim 7, wherein (d) includes:
checking information on a squad of the first user;
comparing the squad of the first user with one of the first and second recommended squad information selected by the game client; and
providing information on the player character lacking in the squad of the first user according to a comparison result.

9. The method of claim 8, wherein (d) further includes
providing acquisition information on the lacking player character to the game client.

10. The method of claim 1, wherein (b) further includes
selecting the at least one second recommended squad information from the first recommended squad information.

11. A system for providing an online sports game in a system for providing an online sports game connectable to at least one game client through a network and providing an online sports game to the at least one game client, comprising:
a squad database for storing squad information including formation information on a management team of each user of the online sports game and per-position player character information;
a squad statistics unit for generating statistics on squads stored in the squad database or a squad on at least one user provided by a game provision controller; and
a game provision controller for generating recommended squad information by selecting n formations that are most frequently used and a per-position player character based on statistics generated by the squad statistics unit, and providing the recommended squad information to a game client.

12. The system of claim 11, wherein the online sports game providing system further includes
a user database for storing management team information and a game ranking on each user of the online sports game, and
the game provision controller selects n users who correspond to game rankings from a first ranking to an n-th ranking, requests squad statistics of the n selected users from the squad statistics unit, and generates recommended squad information based on squad statistics on the n users provided by the squad statistics unit.

13. The system of claim 11, wherein the online sports game providing system further includes
a user database for storing management team information and friend information on each user of the online sports game, and
the game provision controller requests squad statistics on at least one second user registered as a friend of a first user from the squad statistics unit, and generates recommended squad information based on squad statistics on at least one second user provided by the squad statistics unit.

14. The system of claim 12, wherein the online sports game providing system further includes
a player database for storing information on a player character and acquisition information on the player character, and
the game provision controller provides acquisition information on a plurality of player characters included in the recommended squad information to the game client.

15. In a recordable medium for recording a program for executing a method for providing an online sports game, a recording medium for providing a method for providing an online sports game, wherein
the program which is a program that can be driven by an online sports game providing system for providing an online sports game to at least one game client through a network comprises:
(a) a function for generating at least one of first recommended squad information based on statistics on a squad used in the online sports game;
(b) a function for generating at least one of second recommended squad information based on statistics on a squad used by at least one second user relating to a first user; and
(c) a function for providing the at least one of first or second recommended squad information to a game client of the first user.
